(19) United States
(12) Patent Application Publication
(10) Pub. No.: US 2002/0143963 A1
(43) Pub. Date: Oct. 3, 2002

(54) Web server intrusion detection method and apparatus

(75) Inventors: Kim Converse, Austin, TX (US); Ronald O?apos;Neal Edmark, Austin, TX (US)

Correspondence Address: Gregory W. Carr, CARR & STORM, L.L.P., 670 FOUNDERS SQUARE, 900 JACKSON STREET, DALLAS, TX, 75202, US

(73) Assignee: International Business Machines Corporation

(21) Appl. No.: 09/810,028

(22) Filed: Mar. 15, 2001

(51) Int. Cl. G06F 15/16; H04L 9/32

(52) U.S. Cl. 709/229; 713/201

(57) ABSTRACT

Disclosed is an apparatus for enhancing the security of a web server from intrusive attacks in the form of HTTP (hypertext transfer) requests. This is accomplished by comparing an incoming request with a predefined list of attack signatures which may comprise at least files, file categories and IP addresses of known hackers. Action is then taken to reject any requests wherein a positive comparison is determined. Further, the web server is notified of relevant data provided in connection with any rejected request for potential future action in accordance with the severity of potential damage and frequency of rejected requests from a given requestor.

### BACKGROUND OF THE INVENTION

1. Field of the Invention

The present invention relates in general to inappropriate hypertext transfer (HTTP) web server requests.

2. Description of the Related Art

A web server typically comprises a powerful computer connected to the Internet or an Intranet (hereinafter often referred to as simply the “Web”). This computer stores documents and files, such as audio, video, graphics and text, and can display them to entities accessing the server via hypertext transfer protocol (HTTP). These entities normally comprise computer users having access to a web browser. A web browser typically comprises software on a client's computer which is capable of navigating a web of interconnected documents on the worldwide web to allow a user (client) to “surf” the Internet. Thus, it lets a user move easily from one worldwide web site to another. Every time the user stops at or alights on a web page, a request is made of the web server by the web browser to move a copy of the documents on the Web to the user's computer. The use of the HTTP protocol is invisible to the user of the web browser.

A knowledgeable computer user can “fool” a web server into downloading or moving documents or other files to the requesting client's computer that would not be obtainable by a typical user.

Examples of such files might be Common Gateway Interface files which, as a class, are software programs or scripts used by the server, and the names of which are typically terminated by the expression “.cgi”. A specific example being a script named “phf.cgi”. This phf script is a white pages directory service script. Older versions of the script could be exploited into downloading sensitive UNIX password files, for example:

http://your.host.name/cgi-bin/phf?Qalias=x%0a/bin/cat%20/etc/passwd)

A further example of the type of files that a web server would not want distributed or activated within the server for retrieving data are executable helper programs such as perl.exe used in many web servers.

Many web servers store internally used files in directories having commonly known or default names. Thus, the names of these directories may be used as a means of refusing requests for any files contained in these specific directories and, thus, as a means for keeping hackers from snooping around in these directories. As an example, many servers keep all the proprietary “.cgi” scripts in a directory designated as “/cgi-bin/”.

Some web servers may have a “bug” in the software code that is known to hackers whereby a given hexadecimal code may allow the insertion of software code into the operating system of the web server. Thus, a web server needs to provide some means for detecting a request which specifies specific or generalized hexadecimal file names.

Hackers have also been known to send “malformed” HTTP requests to probe a web server for weaknesses in the software code implementation. Sometimes these malformed requests, in the form of hexadecimal characters or “garbage characters,” are designed to “crash” the web server.

The “fooling” of a web server, mentioned supra, may be accomplished by modifying the HTTP request in various presently known and some possibly unknown manners. An example of a request used in an attempt to retrieve a typically used test program or script designated as “test.cgi”, which may normally be stored in a default directory of many web servers, would be a request formulated as “GET/cgi-bin/test.cgi HTTP/1.0”.

Since the distribution of the information contained in some of the documents and/or use of files accessible to a web server could be detrimental to the owner of the server, various techniques have been devised to alert the operator of the web server that such information has been retrieved. This alert is accomplished by reading or examining the access logs of a given web server and comparing the requests previously granted to material contained in a list. Such a list is typically designated as a “signature file,” “list of signatures” or “list of attack signatures,” and such a file or list is formulated to include a majority of the inappropriate material set forth above. When such a comparison is positive, a determination is made that an intrusion/attack against the web server has already occurred at a recorded prior time and/or date.

Such a list may also include the IP (Internet Protocol) addresses of known hackers that the web server administrator has decided should no longer be serviced by the web server. An IP address may also be added to this list, at the discretion of the web server administrator, upon the detection of suspicious activity from a given host (hacker IP address) even though no known harm has occurred.

An example of a software product designed to accomplish this determination is designated as WebIDS (Web Intrusion Detection System) that may be purchased from Tivoli Systems, Inc. as a part of software designated as “Secure Way Risk Manager.” At present, the part number of this product is 5698-RMG. However, by the time such detection has been accomplished, the damage has already been done.

Further information relative vulnerabilities of a web server and exposure of a web server to problems involving a reasonable security policy may be found at various worldwide web sites such as CVE (www.cve.miter.org) and BugTraq (www.securityfocus.com).

It would therefore be desirable to prevent (rather than detect after the fact) any type of inappropriate HTTP request or otherwise intrusive attack on a web server from harming the web server and/or retrieving data that operators of the web server consider to be outside the appropriate responses of the web server function.

### SUMMARY OF THE INVENTION

The present invention comprises a method and an apparatus for preventing unauthorized access to a web server and/or files contained on the web server. This is achieved by comparing a request for data and/or access received by the web server to an attack signature list or a list of files and/or categories of files. If the person requesting the access is contained in the attack signature list or the requested data is contained in the list of files and/or categories of files and/or sets of hexadecimal symbols, then access is denied.

### BRIEF DESCRIPTION OF THE DRAWINGS

For a more complete understanding of the present invention and its advantages, reference will now be made in the following Detailed Description to the accompanying drawings, in which:

FIG. 1 is a flow diagram of actions taken upon intercept of an HTTP request in accordance with this invention;

FIG. 2 is a block diagram of the environment in which this invention is used; and

FIG. 3 provides in block diagram format more details of the components of a web server and a network connected client computer.

### DETAILED DESCRIPTION

As part of this invention, a list, such as the attack signature list referred to above, is compiled by someone in control of or otherwise associated with a web server (often the “administrator”), or other centralized network device used to respond to network client requests for data. This list primarily comprises data and other software, as referenced in the background material above, that is believed to be inappropriate for general dissemination to or use by clients served by the server or other centralized network device.

By definition herein, the terms “intrusive request,” “unauthorized request,” “inappropriate request,” or “intrusive attack” are intended to include any requests, for files or other documents containing data, comprising a part of said list or attack signature file. It should also be noted that although the standardized terminology in the art for the incoming signal is “request,” as set forth above, the signal may well comprise harmful code or characters that can damage a non-secure web server.

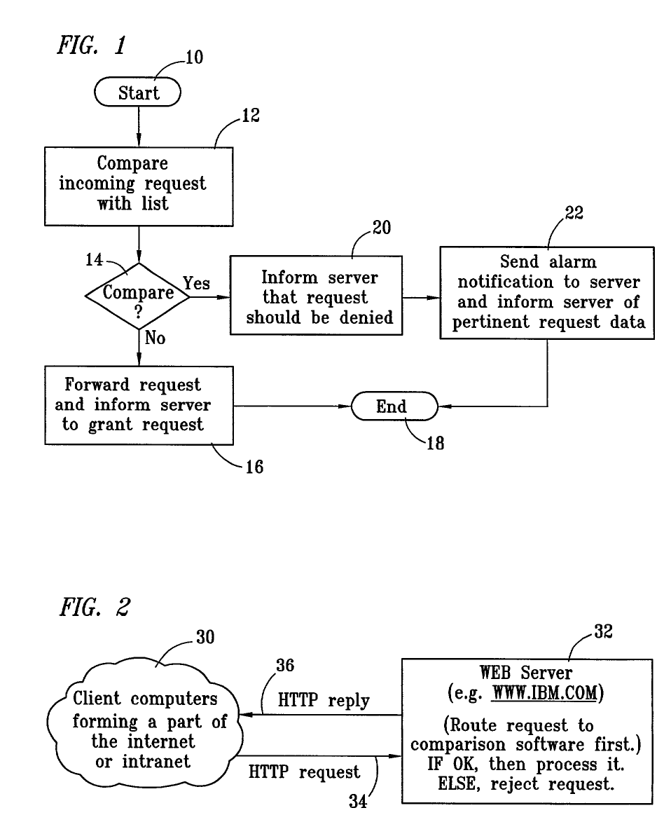

As shown in FIG. 1, the flow diagram of an inappropriate request detection software program would proceed from a start block 10, upon receipt of an incoming HTTP request, to a compare block 12. As stated in block 12, the incoming request is compared with an attack signature file or other predetermined list (not separately and specifically shown) of files and/or categories of files and/or combinations of characters that may be considered to be intrusive or otherwise inappropriate, as well as specific undesirable IP addresses. If a determination is made in a comparison decision block 14 that the request is not inappropriate, the request is forwarded to the prior art software in the web server, as set forth in a block 16. The software, at the option of the software designer or web server administrator, may or may not specifically instruct the web server to grant the request. (However, granting the request would normally be one of the following steps of the web server if the web server is not instructed to deny the request.) The detection program would then proceed to an end block 18 until another HTTP request is detected.

If the compare block 14 detects a positive compare with the list, the program proceeds to a block 20 where the web server is informed that the request should be denied. The prior art software in existing web servers includes a set of well defined return number codes. Among these is a code 400 for the detection of a “bad request.” A code 401 is used for “unauthorized” requests. Another code 403 is used to indicate a “forbidden” request. Any of these referenced codes could readily be used to inform the web server that the request should be denied or otherwise rejected. In appropriate circumstances, an entirely new (unique) return code could be formulated for positive comparisons by the present intrusive attack detection software. From block 20, the software proceeds to block 22 where an alarm notification is sent to the web server along with the pertinent request data. Existing prior art software in the web server notes the severity of the attack and number of prior attacks by the requestor in determining a course of action to be suggested to or followed by the operator of the web server. The software then proceeds to continue to the end block 18 to await the next incoming request.

In FIG. 2, a cloud 30 represents a plurality of client computers comprising a network. This network may well be the well known Internet or any intranet for a given clientele. A block 32 is used to represent a web server, such as might be used for www.ibm.com. An HTTP request, from one of the computers comprising a part of cloud 30, is supplied to block 32 on a line 34. In accordance with the actions presented in FIG. 1, the incoming request is first routed to the comparison software where it is either approved or rejected and the appropriate response is returned to the requestor on a lead 36. Some types or classes of requests may not be responded to in accordance with a determination by the web server's administrator when configuring the existing web server software.

From the background section above, it will be apparent that the exposure of a web server to security related problems covers a wide range of possible attacks from HTTP oriented input signals. However, the present invention, in providing for isolation and examination of an incoming request in an attempt to determine security issues before taking any action to comply with the request or making any rejection response to the request, can drastically limit the likelihood of a reasonable security breach if an up-to-date signature file is used.

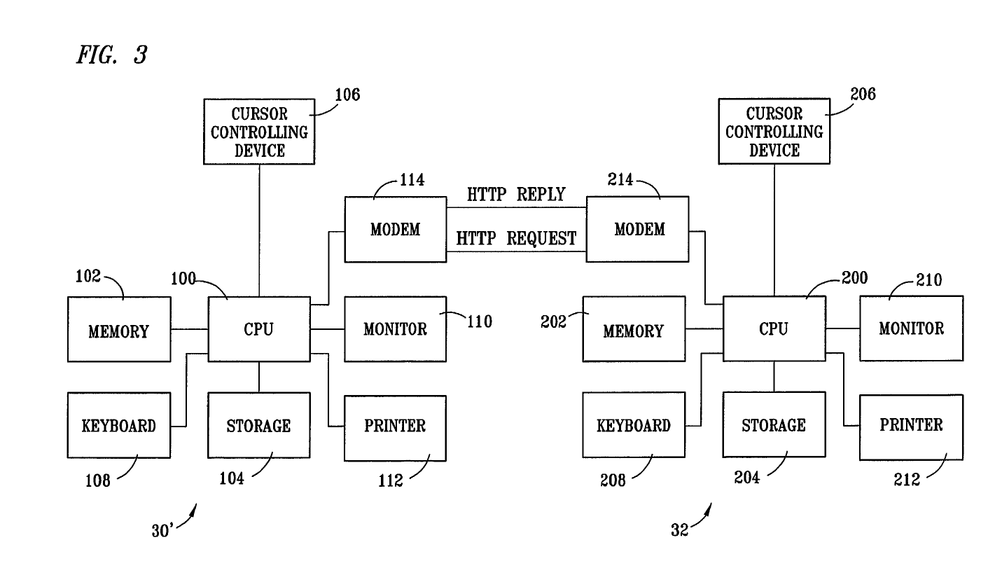

In FIG. 3, a representative computer 30′ of the client computers 30 forming a part of the Internet or Intranet as referenced in FIG. 2 is shown. Within computer 30′, a CPU 100 is illustrated having internal or external memory 102 and data storage 104. Storage apparatus 104 may comprise both internal and removable storage means. Such removable storage may be used to install programs and as backup for potential failure of the computer permanent storage. The CPU 100 is shown being further connected to a cursor controlling device 106, such as a mouse, trackball and so forth. The CPU 100 is further connected to a keyboard 108, a monitor 110 and a printer 112 for entering commands, viewing file contents and program results and printing output, respectively. Various programs are stored in memory 102 and/or in data storage 104 for accessing the Internet (Intranet). The cursor controlling device may be used to select material from the program being used by a client. A modem 114, connected to CPU 100, is used to send requests to and receive responses from a web server 32.

Within server 32 are shown all components used by most computers serving as a web server, although some components, such as a printer, may well be shared with other computers. A CPU 200 is shown being further connected to a cursor controlling device 206, such as a mouse, trackball and so forth. The CPU 200 is further connected to a keyboard 208, a monitor 210 and a printer 212 for entering commands, viewing file contents and program results and printing output, respectively. Various programs are stored in memory 202 and/or in data storage 204 for responding to HTTP requests received and otherwise accessing the Internet (Intranet). The cursor controlling device may be used to select material from any program being used by a web server operational person. A modem 214, connected to CPU 200, is used to receive requests from and provide responses to web clients.

While the computers of FIG. 3 are illustrated as having modems for providing a network interconnection, the modems could be replaced by network cards (Ethernet, Token Ring, and so forth) as appropriate to a given situation. It should also be mentioned that the network computer interconnection communication in a preferred embodiment of the invention is via TCP/IP. TCP/IP (transmission control protocol/Internet protocol) is an internationally recognized standard networking protocol established by the U.S. government.

It should be realized that the attack signature list may be provided in several different manners. It may be part of the code of the program for the interception and comparison of requests or it may be a list prepared by the operator of a server in a specified format and with a given name. The attack signature list may also be in both forms somewhat in the manner of word processing programs having main and supplemental dictionaries. In other words, a suggested attack signature list may be included in the program code. This suggested list may be modified at the server operator's discretion. Further, the web operator may have a list of proprietary programs that are to be protected from outside attack. These programs may be listed in a separate document that the program peruses in conjunction with the suggested list included in the original program.

Although the present invention has been described with reference to a specific embodiment, these descriptions are not meant to be construed in a limiting sense. Various modifications of the disclosed embodiments, as well as alternative embodiments of the present invention, will become apparent to persons skilled in the art upon reference to the description of the present invention. It is therefore contemplated that the claims will cover any such modifications or embodiments that fall within the true scope and spirit of the present invention.

1. A method of minimizing web server inappropriate HTTP (hypertext transfer) requests, comprising the steps of:
comparing an incoming request with a predetermined list; and
refusing a response to requests for files, documents and other signatures included in said predetermined list.

2. A web server, comprising:
input means for receiving hypertext transfer requests;
a list of documents and files to be protected from export;
detection means for comparing the subject matter of hypertext transfer requests with said list; and
output means for supplying, in response to received hypertext transfer requests, only documents and files that are not part of said list.

3. A method of preventing the export from a central serving computer, serving a set of network interconnected client devices, of a predetermined set of data files, comprising the steps of:
compiling a list of data files to be protected from intrusive served network requests;
comparing received data file requests with said list; and
refusing to supply requested data files comprising a part of said list.

4. A method of rejecting unauthorized HTTP (hypertext transfer) requests, comprising the steps of:
preparing a list of files and file categories to be protected from general access;
intercepting HTTP requests directed to a web server;
comparing an incoming request with said list; and
rejecting requests for files within the scope of said list.

5. A method of determining HTTP (hypertext transfer) requests to be rejected, comprising the steps of:
comparing an incoming HTTP request with a predetermined attack signature list; and
rejecting requests for files within the scope of said list.

6. A web server, comprising:
qualifying means for initially determining inappropriateness of incoming HTTP (hypertext transfer) requests; and
means for fulfilling only those requests determined to be appropriate requests.

7. Apparatus as claimed in claim 6, wherein:
said qualifying means includes a list of signatures considered to be inappropriate for positive response; and
comparison means for comparing incoming requests with said list.

8. A method of minimizing web server inappropriate HTTP (hypertext transfer) requests, comprising the steps of:
comparing an incoming request with a predetermined list; and
refusing a response to requests related to signatures included in said predetermined list.

9. A web server, comprising:
input means for receiving hypertext transfer requests;
a list of attack signatures;
comparison means for comparing data included in said hypertext transfer requests with said list; and
output means for rejecting all received hypertext transfer requests comprising a part of said list.

10. A method of determining HTTP (hypertext transfer) requests to be rejected, comprising the steps of:
comparing an incoming HTTP request with an attack signature list; and
rejecting requests within the scope of said list.

11. A computer program product for determining whether or not a web server computer should honor a given file request, the computer program product having a medium with a computer program embodied thereon, the computer program comprising:
computer program code for intercepting incoming HTTP requests upon receipt by the web server computer;
computer program code for comparing incoming HTTP requests with a signature list; and
computer program code for rejecting any requests within the scope of said list.

12. A computer program product for calculating whether or not a given file request to a web server computer is inappropriate, the computer program product having a medium with a computer program embodied thereon, the computer program comprising:
computer program code for comparing an incoming request with a predetermined list; and
computer program code for refusing a response to requests for files, documents and other signatures included in said predetermined list.

13. The computer program product of claim 12, wherein the predetermined list is accessible by the computer program code and is a signature attack list.

14. The computer program product of claim 12, wherein the computer program product further comprises computer program code for intercepting incoming HTTP requests upon receipt of the request by the web server computer.
